(19) United States
(12) Patent Application Publication
(10) Pub. No.: US 2020/0401879 A1
(43) Pub. Date: Dec. 24, 2020

(54) SYSTEMS AND METHODS FOR PREDICTING WHETHER EXPERIMENTAL LEGISLATION WILL BECOME ENACTED INTO LAW

(71) Applicant: LegInsight, LLC, Tumwater, WA (US)

(72) Inventor: Adrian Menard, Tumwater, WA (US)

(73) Assignee: LegInsight, LLC, Tumwater, WA (US)

(21) Appl. No.: 16/446,003

(22) Filed: Jun. 19, 2019

(51) Int. Cl. G06N 3/08; G06Q 50/26; G06N 5/02; G06F 16/27; G06F 16/953

(52) U.S. Cl. CPC G06N 3/08; G06Q 50/26; G06F 16/953; G06F 16/27; G06N 5/02

(57) ABSTRACT

A system and method for predicting whether experimental legislation will become enacted into law may include memory and at least one processor configured to receive a first request which proposes test content as an experimental law and receive a second request pertaining to a selected number of sponsors. The processor may automatically import, over a network, data from databases, prepare the data as predictive modeling data, split the predictive modeling data into two sets of data, train a two-class neural network on training data to predict whether the test law will become law, generate a set of results from the training data, cross-validate the set of results with the test data, and deploy, over the network, a predictive performance.

### BACKGROUND

In the United States, state laws are passed by a state legislature, a legislative body ostensibly modeled on that of the U.S. Congress. State legislatures typically consist of two chambers, the House of Representatives (the term used by 41 of the States) and the Senate (the smaller of the two). To become law, a bill (i.e., a proposed law) must pass a vote in both chambers and then be signed by the state governor. If the governor refuses to sign a bill, known as a veto, it may still become law if both chambers override the veto through a simple majority.

A bill comes into existence by way of being formally proposed by a member of the state legislature, known as the bill's sponsor. Once proposed, it is routed to one or more subject-specializing committees. The committees study the bill and may hold public hearings. Transcripts of the proceedings of state legislature committees are published at the discretion of the committee and are usually publicly unavailable. The committee report is read and often repeatedly read in open sessions for debate. After passing in one chamber, the bill goes through the same or similar procedure in the other chamber. When the bill is accepted in both chambers, it is signed by the respective leaders and sent to the governor.

In any political environment, the legislative process although defined, comprises nuance because the intricacies of lawmaking, such as under-the-table deals, are perhaps, impossible to capture, let alone measure. While political scientists are studying gyrating political trends and ideas, more and more private activists and enterprises are seeking reliance on computer algorithms and data science to predict the outcome of legislation.

### SUMMARY

An embodiment can be a system including memory and having processor readable code stored therein, a plurality of databases each storing a repository of data, and one or more processors communicatively coupled to the memory and configured to execute instructions in the processor readable code that cause the one or more processors to: receive a first request which proposes test content as an experimental law; receive a second request pertaining to a plurality of sponsors; automatically import, over a network, data from the plurality of databases; prepare the data as a plurality of predictive modeling data; split the plurality of predictive modeling data into two sets of data, comprising a set of training data and a set of test data; train a two-class neural network on the training data to predict whether the test law will become law; generate a set of results from the training data; cross-validate the set of results with the test data; and deploy, over the network, a predictive performance, wherein the predictive performance is viewable on a network browser.

Another embodiment can be at least one non-transitory computer readable medium containing processor readable code for programming one or more processors to perform a method including, receiving a first request which proposes test content as an experimental law; receiving a second request pertaining to a plurality of sponsors; importing, automatically over a network, data from the plurality of databases; preparing the data as a plurality of predictive modeling data; splitting the plurality of predictive modeling data into two sets of data, comprising a set of training data and a set of test data; training a two-class neural network on the training data to predict whether the test law will become law; generating a set of results from the training data; cross-validating the set of results with the test data; and deploying, over the network, a predictive performance, wherein the predictive performance is viewable on a network browser.

Yet another embodiment can be a non-transitory computer readable medium storing instructions executable by at least one processing device, the instructions including instructions to: receive a first request which proposes test content as an experimental law; receive a second request pertaining to a plurality of sponsors; automatically import, over a network, data from the plurality of databases; prepare the data as a plurality of predictive modeling data; split the plurality of predictive modeling data into two sets of data, comprising a set of training data and a set of test data; train a two-class neural network on the training data to predict whether the test law will become law; generate a set of results from the training data; cross-validate the set of results with the test data; and deploy, over the network, a predictive performance, wherein the predictive performance is viewable on a network browser.

Naturally, further objects of embodiments are disclosed throughout other areas of the specification, drawings, photographs, and claims.

### BRIEF DESCRIPTION OF THE DRAWINGS

Corresponding reference numerals indicate corresponding parts throughout the several views of the drawings.

FIG. 1 is a schematic view of an embodiment of a legislative codification predictor;

FIG. 2 is a schematic view of an embodiment of the system architecture of the legislative codification predictor of FIG. 1;

FIG. 3 is a block diagram view of an embodiment of routines of the legislative codification predictor;

FIG. 4 is a screen shot of an embodiment of the legislative codification predictor;

FIG. 5 is a screen shot of an embodiment of the Bill Drafting module of the legislative codification predictor of FIG. 4;

FIG. 6 is a screen shot of an embodiment of the Bill Drafting module of the legislative codification predictor of FIG. 5; and

FIG. 7 is a screen shot of an embodiment of the Session Results module of the legislative codification predictor of FIG. 4.

The drawings described herein are for illustrative purposes only of select embodiments and not all possible implementations, and are not intended to limit the scope of the present disclosure.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation. Moreover, it is to be appreciated that the drawings may not be to scale.

According to embodiments, a legislative codification predictor 1000 relates to systems and methods for predicting whether experimental legislation will become enacted into law. Embodiments of the present disclosure may be implemented using a general-purpose computer. Alternatively, a special-purpose computer may be built using suitable logic elements.

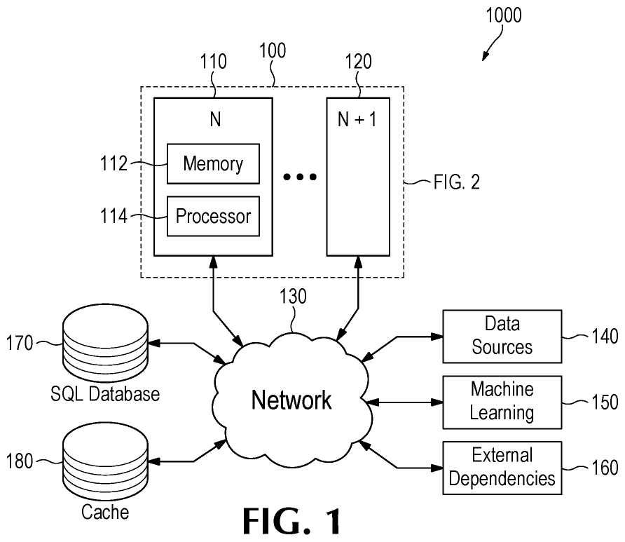

FIG. 1 is a schematic illustrating an embodiment of a legislative codification predictor 1000, including a series (1-n) of hosted servers 100 connected by a Network 130 to Data Sources 140; Machine Learning Services 150; External Dependencies 160; and one or more Databases 170 and Cache 180. While only two servers (110, 120) of the hosted servers 100 are shown in FIG. 1, embodiments of the legislative codification predictor 1000 are not limited by the number of hosted servers 100. The illustrative example of the hosted servers 100 of the legislative codification predictor 1000 is not intended to preclude embodiments which incorporate similar or equivalent single or multiple blade servers and server farms.

Server N 110 and server N+1 120 of the series (1-n) of hosted servers 100 include Memory 112 and Processor 114. The Memory 112 holds instructions in processor-readable code used by the Processor 114. The Processor 114 can be communicatively coupled to the Memory 112 and configured to execute the instructions in the processor-readable code. Server N 110 and server N+1 120 of the series (1-n) of hosted servers 100 can include more than one Memory 112 and more than one Processor 114. The hosted servers 100 are adapted to execute computer programmable logic used to provide specified functionality. The computer programmable logic can be implemented in hardware, firmware, and/or software.

The Network 130 provides a communication infrastructure between the hosted servers 100 and Data Sources 140, Machine Learning services 150, External Dependencies 160, Database 170, and Cache 180. The Network 130 is typically the Internet, but may be any network, including but not limited to a Local Area Network (LAN), a Metropolitan Area Network (MAN), a Wide Area Network (WAN), a mobile wired or wireless network, a private network, or a virtual private network.

Data Sources 140 can be public data sources in the form of various uniform resource locators (URLs) pertaining to the desired state government intended to be analyzed. For example, in a non-limiting embodiment, URLs for Washington State include Washington State Legislative Web Service at http://wslwebservices.leg.wa.gov, Washington State Legislature at http://leg.wa.gov, Washington State Public Disclosure Commission at https://www.pdc.wa.gov, and the Office of Financial Management at https://ofm.wa.gov.

Machine Learning 150 can be a cloud-based service used to manage machine learning models. A commercially available example of a machine learning service is Azure Machine Learning by Microsoft®, which fully supports open-source technologies. The illustrative example of the Machine Learning service 150 of the legislative codification predictor 1000 is not intended to preclude embodiments which incorporate similar or equivalent data science techniques.

With continuing reference to FIG. 1, External Dependencies 160 can include an email service. A commercially available email service provider is SendGrid®. In addition, External Dependencies 160 can include a billing platform. A commercially available billing and payment platform provider is Recurly®. The examples of the External Dependencies 160 of the legislative codification predictor 1000 are not intended to preclude embodiments which incorporate similar or equivalent external dependency relationships with other additional service providers both commercially and prospectively available.

Database 170 can be a structured query language (SQL) database communicatively coupled to the hosted servers 100 via the Network 130. In various embodiments, the Database 170 can be a no structured query language, a key value store, and a MapReduce. Cache 180, as an additional database to Database 170 can be communicatively coupled to the hosted servers 100 via the Network 130. In various embodiments, Cache 180 can be in memory cache, distributed cache, and disk cache. The illustrative examples of the Database 170 and Cache 180 of the legislative codification predictor 1000 are not intended to preclude embodiments which incorporate similar or equivalent data managing languages and data storing media.

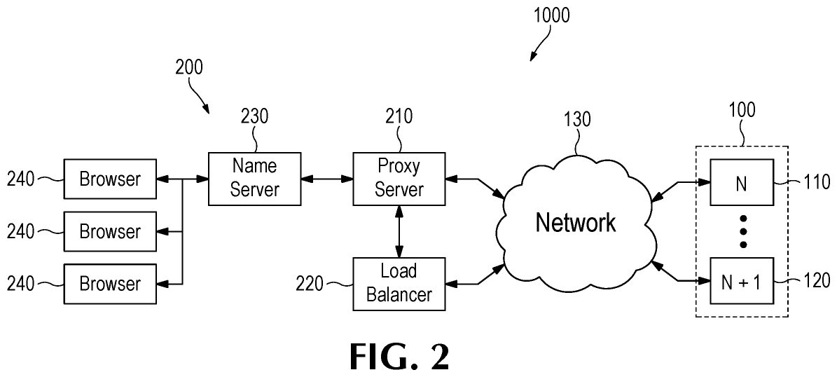

Referring to FIG. 2, a legislative codification predictor 1000 can be implemented according to a client-server system, which can include a client-side portion executed on a user Browsers 240 and a server-side portion executed on a server system 200, which includes the hosted servers 100 of FIG. 1.

The Network 130 provides a communication infrastructure between Proxy Server 210 and Name Server 230. Proxy Server 210 can be a content delivery network(s) (CDN) geographically distributed spatially relative to the users. Load Balancer 220 can distribute packets of data across multiple servers of the Proxy Server 210. Name Server 230 is a URL, such as https://www.leginsight.com accessible by Browsers 240.

Browsers 240 can be viewed on any electronic device, such as a desktop computer, laptop computer, tablet computer, person digital assistant, mobile phone (e.g., smartphone), or wearable electronic device (e.g., digital glasses, wristband, wristwatch, etc.).

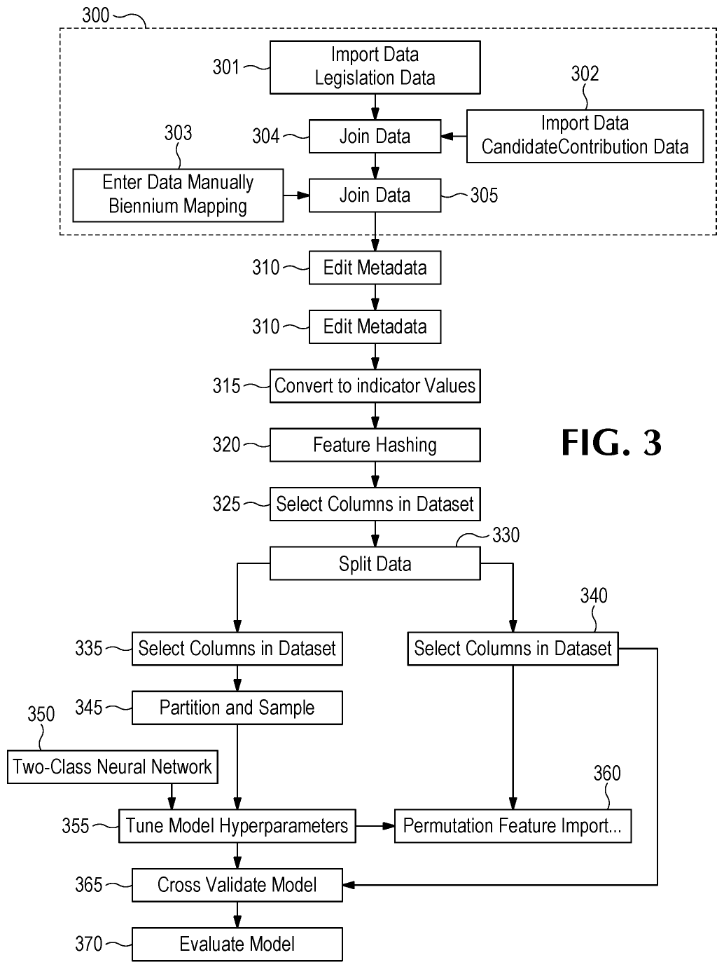

FIG. 3 is a flow chart illustrating a process for generating predictive performance results pertaining to a probability that an experimental or test law will pass, according to one embodiment. Other embodiments may perform the process steps in different orders. In addition, other embodiments may include different and/or additional steps than the ones described herein. Other embodiments may also omit steps described herein.

In FIG. 3, data importation 300 involves an import of Legislation Data 301 from, data sources, which can include various URLs pertaining to the desired state government intended to be analyzed. Next, Candidate Contribution Data is imported 302, then data is entered manually 303 in order to map data points based on a specified period of time (e.g., biennium). Each of the Candidate Contribution Data imported 302 and the manually entered data 303 is joined in steps 304 and 305.

In Edit Metadata steps (310, 310) legislative features that are numerical, such as Total Contributions and Fiscal Impact are made non-categorical and numerical identifiers, such as Prime Sponsor are made categorical.

Next, the categorical identifiers are Converted to Boolean Indicator Values in step 315, thereby generating a true/false column for every value of the categorized feature (i.e., Prime Sponsor).

In Feature Hashing 320, a hashing algorithm with hashing bitsize: 10 and N-grams: 2 is used to create unique values (i.e., Long Description of pending legislation).

The raw data columns that have been cleaned and prepped according to the feature engineering of Feature Hashing 320 are excluded in Set Columns in Dataset 325.

With continuing reference to FIG. 3, in Split Data 330 the data is split into 70% training and 30% test data sets using a non-stratified split. In another embodiment, the data can be split along biennium boundaries rather than randomly.

In Select Columns in Dataset (335, 340), the biennium column is next excluded.

In Partition and Sample step 345 of the process, the data is randomly partitioned evenly along 10 folds by creating 10 different groupings of the data.

Next, the 10 folds from Partition and Sample 345 are evaluated and optimized for F-score and mean absolute error to determine the best hyperparameters to tune the Two-Class Neural Network 350 in the Tune Model Hyperparameters step 355.

In Two-Class Neural Network 350 the two-class neural network is trained on the training data to predict a whether a bill will become law or not. The parameters of the training are determined by the previous step, Partition and Sample 345.

In Cross Validate Model 365, the trained model results are cross validated with the test data that has been held back from Split Data step 330.

Permutation Feature Importance 360 determines the most statistically significant features in making the prediction.

In Evaluate Model 370 results are generated and the predictive performance of the algorithm on the test data is shown to the user. The ROC, Precision/Recall and Lift graphs (described below) are generated in the Evaluate Model 370 step.

In Table 1, the ROC Curve summarizes the trade-off between the true positive rate and false positive rate for a predictive model using different probability thresholds. The Precision-Recall curve summarizes the trade-off between the true positive rate and the positive predictive value for a predictive model using different probability thresholds.

Table 2 is generated from the same data as used in Table 1 with Recall and Precision as the x axis and the y axis.

$$Precision = \frac{truepositives}{truepositives + falsepositives}$$

$$Recall = \frac{truepositives}{truepositives + falsenegatives}$$

Table 3 is generated from the same data used in Table 1 and Table 2 with Positive Rate and Number of True Positives as the x axis and the y axis.

$$l ift = \frac{P ( A ⋂ B )}{P ( A ) * P ( B )}$$

F1 score is a measure of low false positives and low false negatives and it is the harmonic mean of Precision and Recall.

$${F}_{1} = {( \frac{{recall}^{- 1} + {precision}^{- 1}}{2} )}^{- 1} = 2 \cdot \frac{precision \cdot recall}{precision + recall} .$$

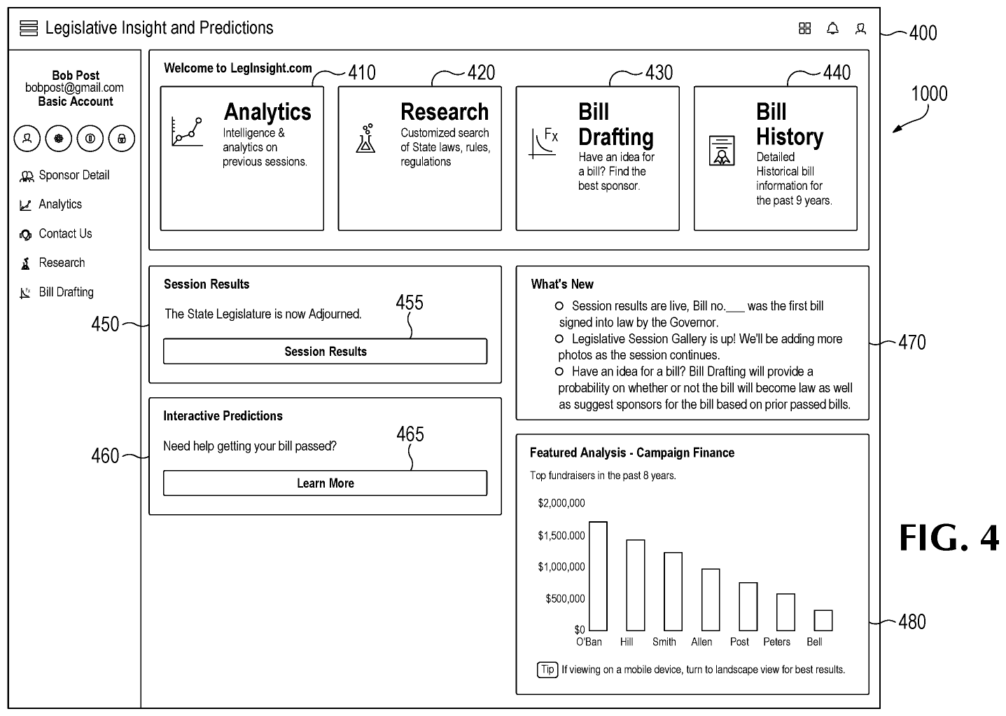

Referring to FIG. 4, user interface 400 of the legislative codification predictor 1000 can be viewed by users accessing https://www.leginsight.com via Browsers 240 of FIG. 2. By selecting Analytics module 410, the user accesses intelligence on previous legislative sessions by way of graphs and charts 480, including who sponsored the most bills in the previous biennia or which legislators raised the most campaign contributions. Research module 420 provides a custom search to allow the user to research state laws, rules, and regulations quickly. The Bill Drafting module 430 (to be described) allows the user to test whether an experimental bill will become passed into law, as well as find the best sponsor to champion the bill through the legislature chambers. If the user is interested in bill from previous legislative sessions, Bill History module 440 enables the user to search through 9 years of introduced bills.

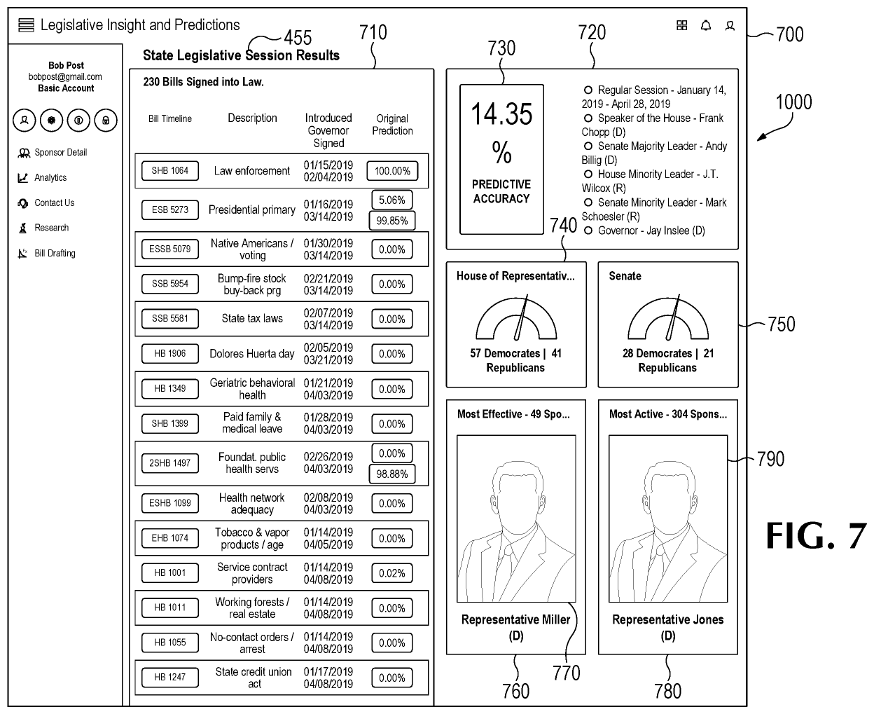

Session Results module 450 includes a Session Results bar 455 to quickly view what bills have passed in a particular session and additional statistics about the session. Session Results module 450 will be described further in reference to FIG. 7.

With continuing reference to FIG. 4, Interactive Predictions module 460 via Learn More bar 465 takes the user to the pricing page to allow the user to purchase a subscription to the web site.

The What's New window 470 provides users with the latest news, including, for example, live results of the first bill signed into law by the governor for the latest session.

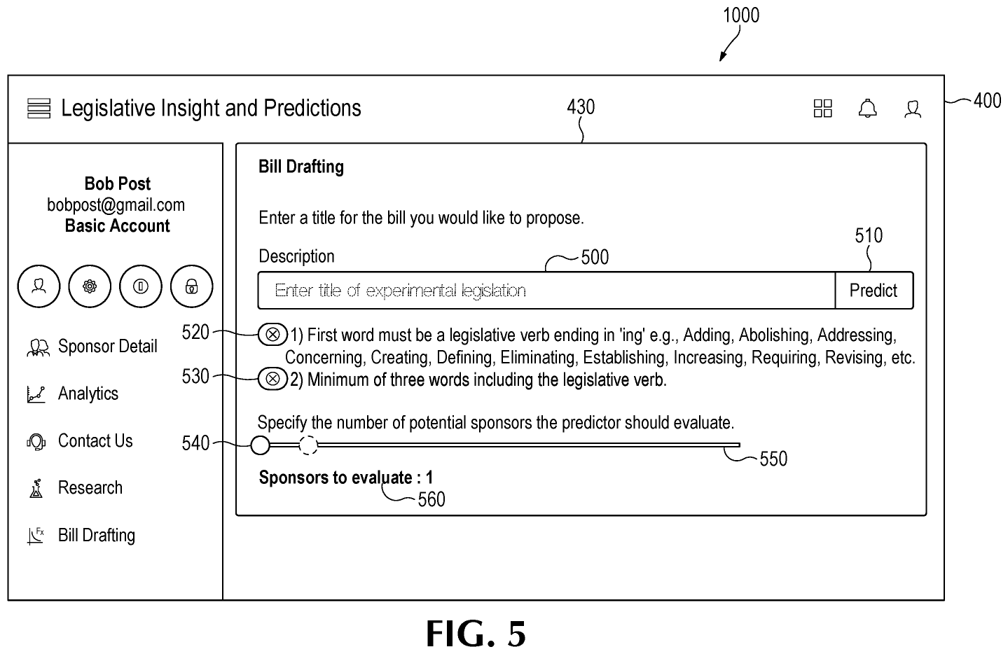

FIG. 5 depicts the Bill Drafting dashboard 400 of the legislative codification predictor 1000 after the Bill Drafting module 430 has been selected by the user. The Bill Drafting module 430 includes a field bar 500 for allowing the user to enter a title of an experimental bill. First signal button 520 will turn from red to green in color upon entering in the field bar 500 a first word that satisfies the legislative verb requirement. Second signal button 530 will turn from red to green in color upon reaching the minimum of three words entered in the field bar 500. Next, the user can slide the toggle button 540 along the length of the slide line 550 to accept the number of potential sponsors the legislative codification predictor 1000 should evaluate. The number of Sponsors to evaluate 560 will rise and fall through actuation of the toggle button 540 back and forth along the slide line 550. After completing the above, the user can then select the Predict tab 510.

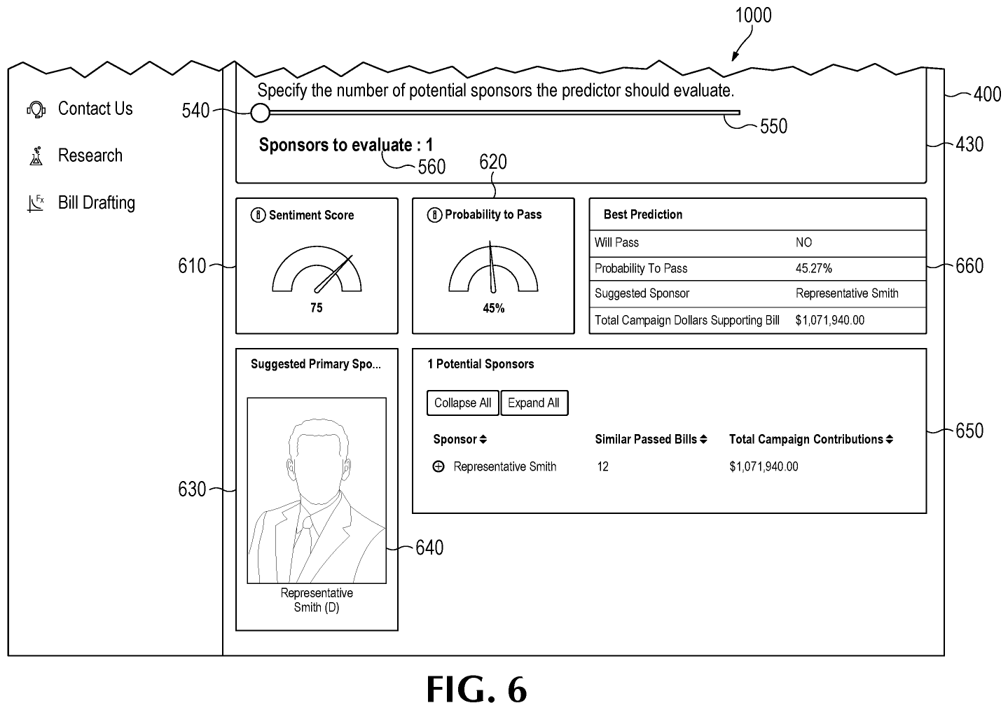

Referring to FIG. 6, a continuation scroll of Bill Drafting dashboard 400 of FIG. 5 is illustrated, showing the predictive results of the experimental law entered in the Bill Drafting module 430 of the legislative codification predictor 1000. Sentiment Score feature 610 is indicated between zero to 100 along with Probability to Pass feature 620 calculated in 0% to 100%. The Suggested Primary Sponsor(s) 630 is also provided, including a photograph 640 of the sponsor. Additional analytics are provided in the Potential Sponsors window 650, including the Total Campaign Contributions and Number of Similar Bills Passed. The Best Prediction window 660 provides a YES or NO indication that the experimental bill will pass, a Probability to Pass score, the Suggested Sponsor, and the Total Campaign Dollars Supporting the Bill.

With reference to FIG. 7, a depiction is shown of the Session Results dashboard 700 of the legislative codification predictor 1000, after the Session Results module 455 has been selected. The Bills Signed into Law window 710 provides all of the bills signed into law for the corresponding session. Also, Bill Timeline, Bill Description, Date of Introduction, Date when Governor Signed, an Original Prediction probability is provided for each bill. Further, Session Results window 720 includes the date the session began and ended, the name and party of the Speaker of the House, the name and party of the Senate Majority Leader, name and party of the House Minority Leader, the name and party of the Senate Majority Leader, and the name and party of the Governor. Included within Session Results window 720 is a Predictive Accuracy window 730 to indicate the probability results of the entire session.

In FIG. 7, both chambers' party-boundaries are delineated with Democrats in blue and the Republicans in red, showing the results in a metered needle gauge configuration (740, 750). Included in the Most Effective Sponsor window 760 is a photograph 770 and the name and party of the sponsor most effective for the session. The Most Active Sponsor window 780 also includes a photograph 790 and the name and party of the sponsor most active during the session.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, Ultra HD Blu-ray, or other optical drive media.

The description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used is for the purpose of describing particular example embodiments only and is not intended to be limiting. The singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath,” “below,” “lower,” “above,” “upper,” and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, quadrants, thirds, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims. All references recited herein are incorporated herein by specific reference in their entirety.

1. A system, comprising:
memory, having processor readable code stored therein;
a plurality of databases each storing a repository of data; and
one or more processors communicatively coupled to the memory and configured to execute instructions in the processor readable code that cause the one or more processors to:
transmit from a user a first request which generates test content as an experimental law, the experimental law proposing language directed to a not-yet-drafted bill;
transmit from the user a second request pertaining to a selection by the user of an amount of potential sponsors of the not-yet-drafted bill;
automatically import, over a network, data from the plurality of databases;
prepare the data as a plurality of predictive modeling data;
split the plurality of predictive modeling data into two sets of data, comprising a set of training data and a set of test data;
train a two-class neural network on the training data to evaluate a predictive performance of the not-yet-drafted bill;
generate a set of results from the training data;
cross-validate the set of results with the test data; and
deploy, over the network, a predictive performance, wherein the predictive performance is viewable on a network browser.

2. The system of claim 1, wherein the predictive performance comprises a probability to pass.

3. The system of claim 2, wherein the predictive performance comprises a suggested primary sponsor.

4. The system of claim 3, wherein the predictive performance comprises a total amount of campaign contribution dollars.

5. The system of claim 1, wherein the plurality of databases comprise at least one database of a structured query language, a no structured query language, a key value store, and a MapReduce.

6. The system of claim 5, wherein the plurality of databases comprise at least one of in memory cache, distributed cache, and disk cache.

7. The system of claim 1, wherein the system further comprises a proxy server and a load balancer as a content delivery network communicatively coupled to the network browser.

8. At least one non-transitory computer readable medium containing processor readable code for programming one or more processors to perform a method comprising:
transmitting from a user a first request which generates test content as an experimental law, the experimental law proposing language directed to a not-yet-drafted bill;
transmitting from the user a second request pertaining to a selection by the user of an amount of potential sponsors of the not-yet-drafted bill;
importing automatically over a network, data from the plurality of databases;
preparing the data as a plurality of predictive modeling data;
splitting the plurality of predictive modeling data into two sets of data, comprising a set of training data and a set of test data;
training a two-class neural network on the training data to evaluate a predictive performance of the not-yet-drafted bill;
generating a set of results from the training data;
cross-validating the set of results with the test data; and
deploying, over the network, a predictive performance, wherein the predictive performance is viewable on a network browser.

9. The method of claim 8, wherein after the importing step, the method further comprises editing metadata.

10. The method of claim 9, wherein after the editing metadata step, the method further comprises converting categorical identifiers to Boolean indicator values.

11. The method of claim 10, wherein after the splitting step, the method further comprises optimizing hyperparameters to tune the two-class neural network.

12. The method of claim 8, wherein the predictive performance comprises a probability to pass.

13. The method of claim 12, wherein the predictive performance comprises a suggested primary sponsor.

14. The method of claim 13, wherein the predictive performance comprises a total amount of campaign contribution dollars.

15. A non-transitory computer readable medium storing instructions executable by at least one processing device, the instructions including instructions to:
transmit from a user a first request which generates test content as an experimental law, the experimental law proposing language directed to a not-yet-drafted bill;
transmit from the user a second request pertaining to a selection by the user of an amount of potential sponsors of the not-yet-drafted bill;
automatically import, over a network, data from the plurality of databases;
prepare the data as a plurality of predictive modeling data;
split the plurality of predictive modeling data into two sets of data, comprising a set of training data and a set of test data;
train a two-class neural network on the training data to evaluate a predictive performance of the not-yet-drafted bill;
generate a set of results from the training data;
cross-validate the set of results with the test data; and
deploy, over the network, a predictive performance, wherein the predictive performance is viewable on a network browser.

16. The system of claim 15, wherein the predictive performance comprises a probability to pass.

17. The system of claim 16, wherein the predictive performance comprises a suggested primary sponsor.

18. The system of claim 17, wherein the predictive performance comprises a total amount of campaign contribution dollars.

19. The system of claim 15, wherein the plurality of databases comprise at least one database of a structured query language, a no structured query language, a key value store, and a MapReduce.

20. The system of claim 19, wherein the plurality of databases comprises at least one of in memory cache, distributed cache, and disk cache.

21. The system of claim 15, wherein the system further comprises a proxy server and a load balancer as a content delivery network communicatively coupled to the network browser.
